(19) United States
(12) Patent Application Publication
(10) Pub. No.: US 2021/0270108 A1
(43) Pub. Date: Sep. 2, 2021

(54) DEBRIS COLLECTION TOOL

(71) Applicant: Weatherford Technology Holdings, LLC, Houston, TX (US)

(72) Inventor: Matthew Daniel GARCIA, Houston, TX (US)

(21) Appl. No.: 16/805,941

(22) Filed: Mar. 2, 2020

(51) Int. Cl. E21B 37/00

(52) U.S. Cl. CPC E21B 37/00; H01F 7/0221

(57) ABSTRACT

A method and apparatus for operating a debris removal tool. In one embodiment, the tool includes a cover assembly having a plurality of covers spaced from one another along the length of the assembly creating a gap between adjacent covers. A carrier disposed within the cover assembly is axial movable relative thereto and has a plurality of magnet groups spaced from one another along its length. In an unactuated position of the tool, each of the plurality of magnet groups is under one of the plurality of covers and in an actuated position, each of the plurality of magnets is in a gap between covers.

### BACKGROUND OF THE INVENTION

### Field of the Invention

The present invention relates to wellbore tools. More specifically, the invention relates to a debris collection tool utilizing magnets to collect metallic debris in a wellbore.

### Description of the Related Art

Many operations in an oil or gas well often produce a variety of debris in the wellbore. For example, milling operations may produce metallic mill cuttings, which may not be completely removed by simple circulation of fluid in the wellbore. Retrieval tools containing magnets have been used to collect the debris in wellbores. Magnetic retrieval tools typically have magnets disposed on the exterior of the tool. Having the magnets continuously attracting metallic objects is problematic as there are times when the tool needs to be non-attractive to debris, like during run-in. Some tools have electro magnets that can be turned on and off remotely from the surface. These are unreliable and often require a source of power downhole. In any case, having magnets exposed even when not in use increases the chance of damage and malfunction.

There is a need, therefore, for an improved magnetic retrieval tool for retrieving debris from the wellbore.

### SUMMARY OF THE INVENTION

The present invention generally relates to a debris removal tool for use in a wellbore. In one embodiment, the tool includes a cover assembly having a plurality of covers spaced from one another along the length of the assembly creating a gap between adjacent covers. A carrier disposed within the cover assembly is axial movable relative thereto and has a plurality of magnet groups spaced from one another along its length. In an unactuated position of the tool, each of the plurality of magnet groups is under one of the plurality of covers and in an actuated position, each of the plurality of magnets is in a gap between covers. In another embodiment, a method of operating the tool includes running the tool into the wellbore on a string of tubulars to a predetermined depth and thereafter, providing fluid pressure to a piston surface formed on the carrier thereby causing the tool to move from a deactivated position wherein the magnets are covered, to an activated position wherein the magnets are exposed to the wellbore.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a cover assembly.

FIG. 2 is an exploded view of the cover assembly.

FIGS. 3A and 3B are perspective views of a magnet assembly.

FIG. 4 is a front view of the assembled tool.

FIGS. 5 and 6 are section views of the deactivated tool taken along lines 5-5 and 6-6 of FIG. 4.

FIG. 7 is a section view showing the relationship between the covers and magnets of the tool in its deactivated position.

FIG. 8 is an enlarged section view showing an upper actuation portion of the tool.

FIG. 9 is an enlarged section view showing a lower actuation portion of the tool.

FIG. 10 is a front view of a wavy ring in its natural, wavy state.

FIG. 11 is the enlarged section view of FIG. 9 with the wavy washer shown in a flattened state.

FIG. 12 is the enlarged section view of FIG. 11 showing the tool moving to an actuated position.

FIG. 13 is an enlarged section view of FIG. 12 showing the tool in its final activated position.

FIG. 14 is a section view showing an upper portion of the unactuated tool in a wellbore.

FIG. 15 is a section view showing an upper portion of the actuated tool in a wellbore.

FIG. 16 is a section view of a reset assembly shown with the tool in the unactuated position.

FIG. 17 is a section view of the reset assembly shown with the tool in the actuated position.

FIG. 18 is a section view of the reset assembly shown after the tool has been reset.

### DETAILED DESCRIPTION

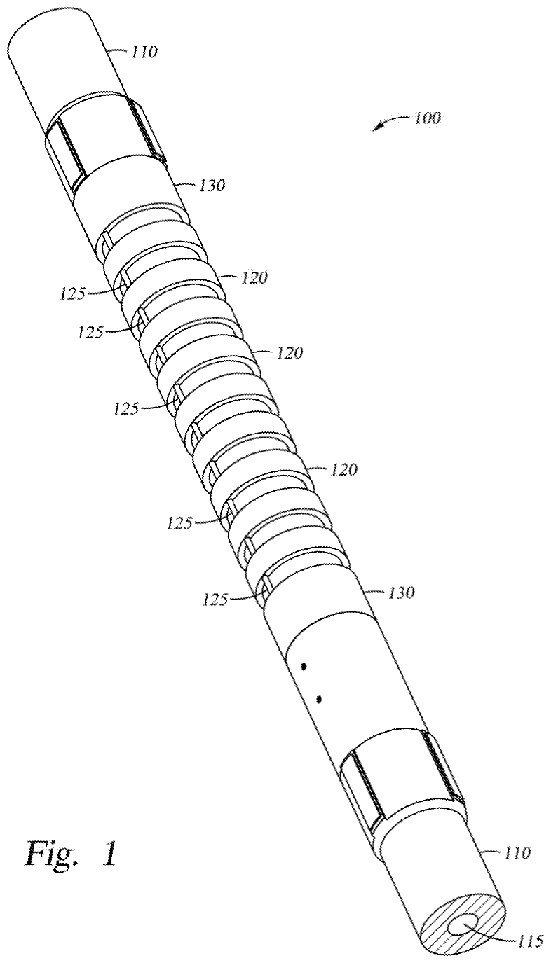

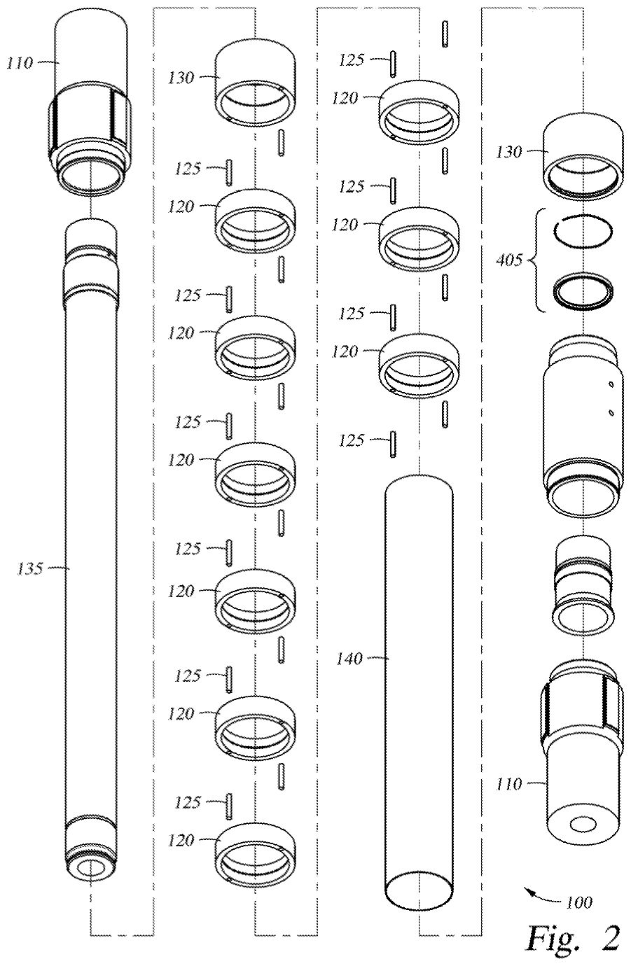

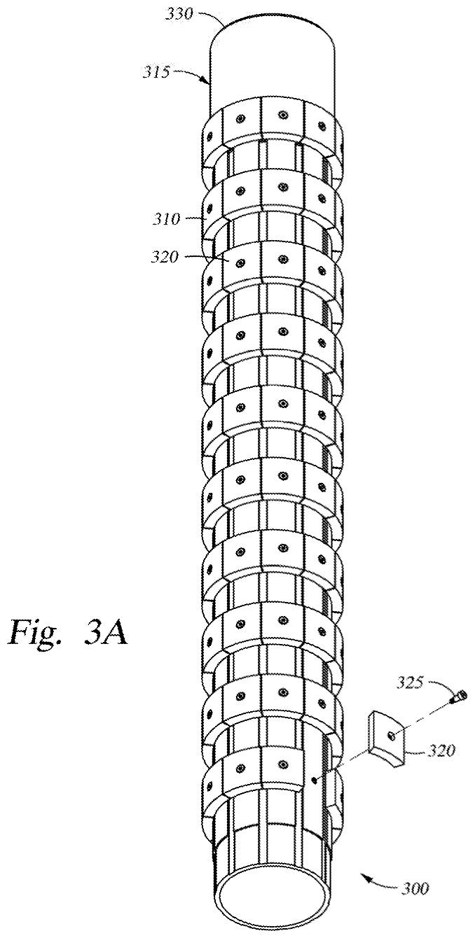

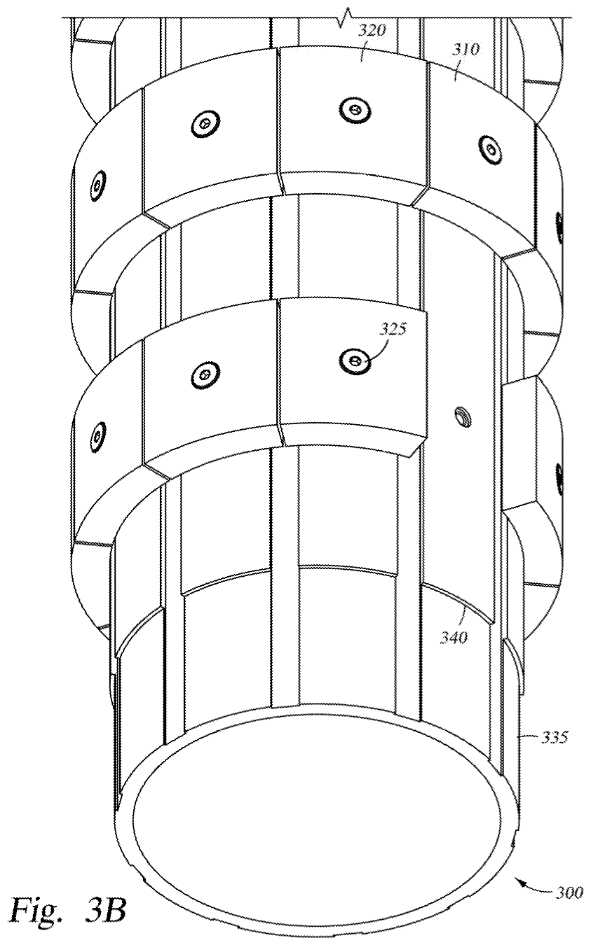

The debris removal tool 500 of the present invention is primarily made up of two assemblies: a cover assembly and a magnet assembly. FIG. 1 is a perspective view of the cover assembly 100. The assembly is constructed and arranged to cover a magnet assembly 300 (FIG. 3A, B) that moves axially within the cover assembly to expose or cover a plurality of magnet groups 310. The cover assembly 100 includes an upper and lower end caps 110 and includes a bore 115 extending the length of the assembly. The assembly also includes a plurality of spaced covers 120 each of which is separated from an adjacent cover by spacer pins 125. Upper and lower end covers 130 are wider than the other covers. FIG. 2 is an exploded view of the cover assembly 100 of FIG. 1. Visible in the exploded view are the end caps 110, covers 120, and spacer pins 125 introduced in FIG. 1. Additionally visible are an inner tube 135, a particle shield 140, and a ring assembly 405.

FIGS. 3A and 3B are perspective views of the magnet assembly 300. The magnet assembly, in the embodiment shown is installed inside and axially movable within the cover assembly 100 in a manner whereby magnet groups 310 are covered when the tool is in a deactivated position but exposed in an activated position. The assembly 300 includes a carrier 315 having a bore therethrough. Each magnet group consists of magnets disposed radially around the body of the carrier. Each individual magnet 320 is attached to the carrier by a fastener 325. In addition to housing the magnets, the carrier has a piston surface 330 at an upper end and acts as an annular piston to shift the magnet assembly 300 between the two positions of the tool. FIG. 3B is an enlarged view of a lower end of the carrier 315. As shown, the carrier has a reduced diameter portion 335 at a lower end with a shoulder 340 formed at a transition point between the two outer diameters. The reduced diameter portion and shoulder are integral to shifting the tool as will be explained herein.

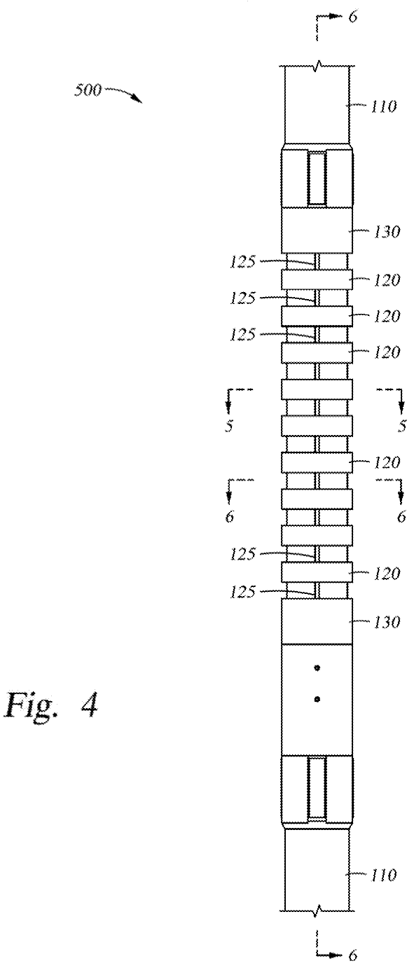

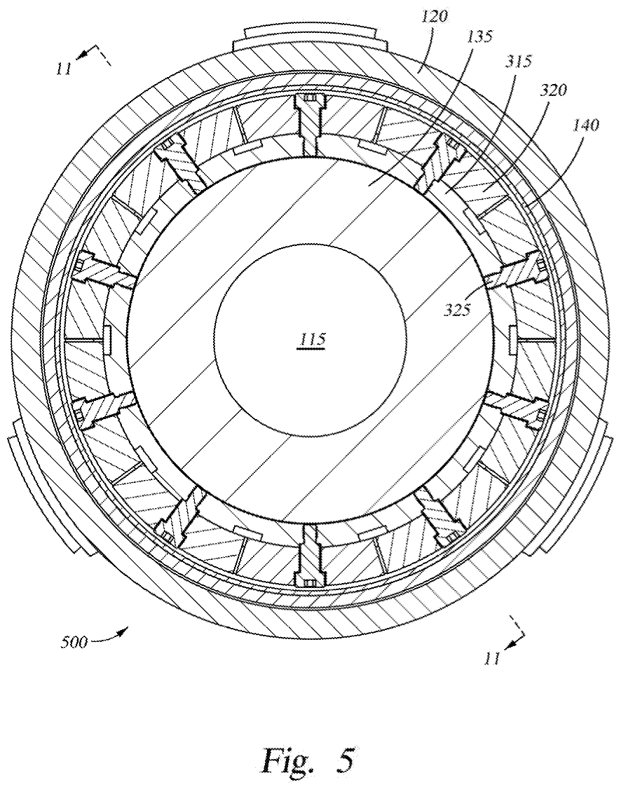

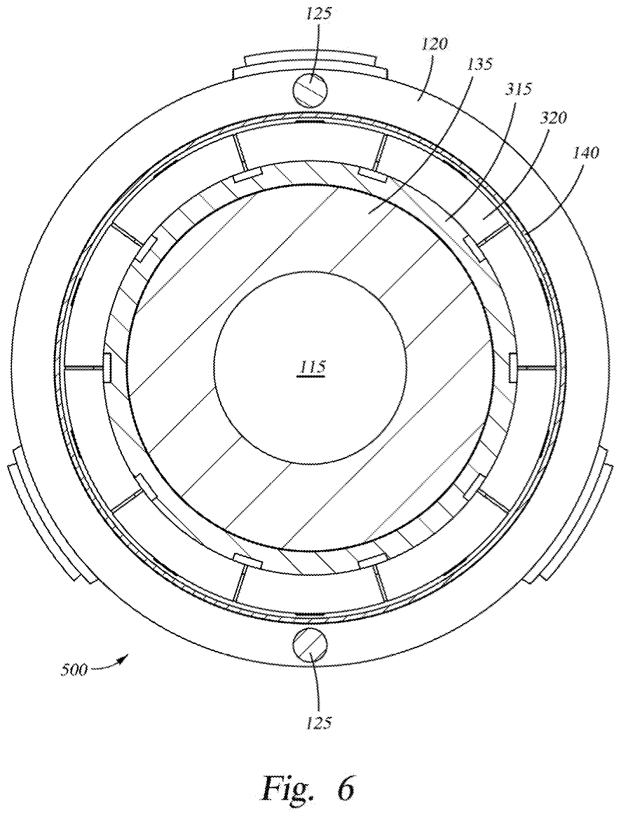

FIG. 4 is a front view of the assembled tool 500 showing the covers 120, 130 as well as the spacer pins 125 separating the covers. FIGS. 5 and 6 are section views of the deactivated tool 500 taken along lines 5-5 and 6-6 of FIG. 4. At the center of FIG. 5 is bore 115 formed in the inner tube 135 of the cover assembly 100. Surrounding the inner tube and axially movable relative to the inner tube is the carrier 315 and mounted on its outer surface are the magnets 320 attached to the carrier in radial groups 310 with the fasteners 325 also visible in the Figure. Surrounding the carrier 315 and magnet groups 310 is the particle shield 140 with a space provided between the two parts. As will be shown and explained herein, the particle shield 140 is a thin member that functions to prevent magnetically attracted debris from actually coming into contact with the magnets 320. Covering the particle shield is one of the covers 120 with a space between the two parts. FIG. 6 is a section view taken through another portion of the deactivated tool 500. The inner tube 135, carrier 315, and particle shield 140 are visible as well as two of the spacer pins 125. The magnets 320 and cover 120 are labeled but not directly visible in the section view of FIG. 6.

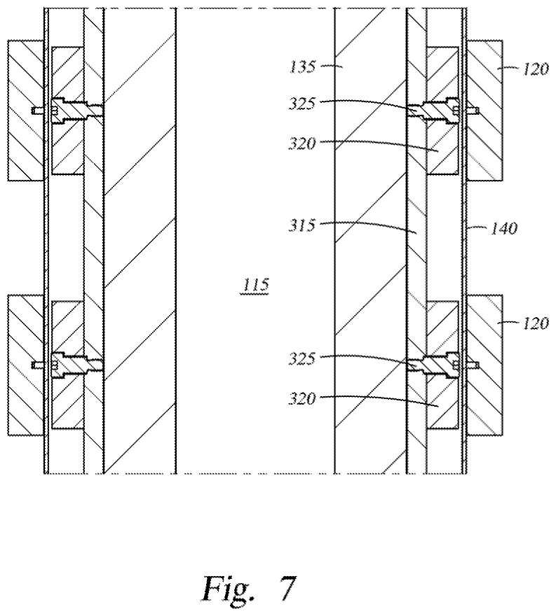

FIG. 7 is a section view showing the relationship between the covers 120 and magnets 320 of the tool 500 in its deactivated position. Visible is the inner tube 135, carrier 315, magnets 320, fasteners 325, covers 120 and particle shield 140. In the deactivated position, each magnet is underneath a cover preventing its magnetic properties from escaping to the wellbore (not shown) surrounding the tool 500. As will be illustrated and described herein, shifting the tool to the activated position includes moving the carrier with the attached magnets downwards in relation to the covers 120 in order to expose them to debris in the wellbore.

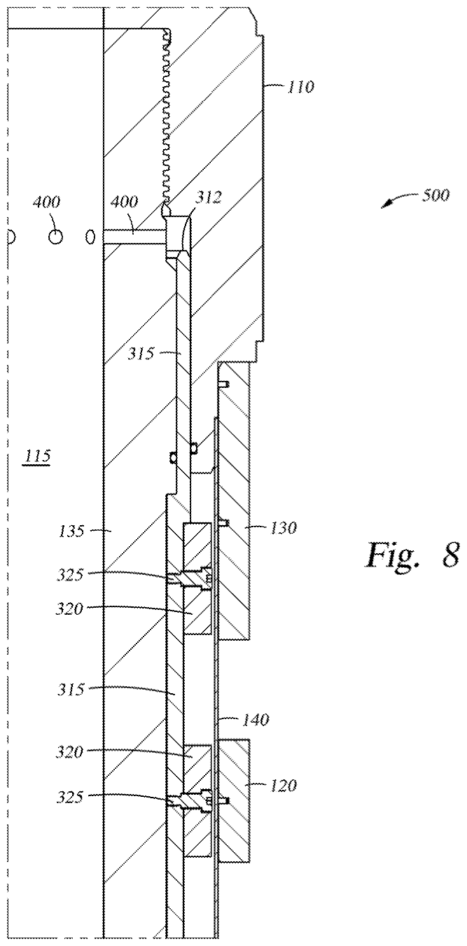

FIG. 8 is an enlarged section view showing an upper actuation portion of the tool 500. As explained, an upper surface 312 of the carrier 315 operates as a piston surface causing the carrier to operate as an annular piston when a predetermined fluid pressure is placed on surface 312. Shown in the Figure is a port 400 creating a fluid path between the bore of the tool and surface 312. As the tool 500 moves to the activated position, the carrier and magnets will move down to a location wherein the magnets are no longer blocked by the covers 130, 120.

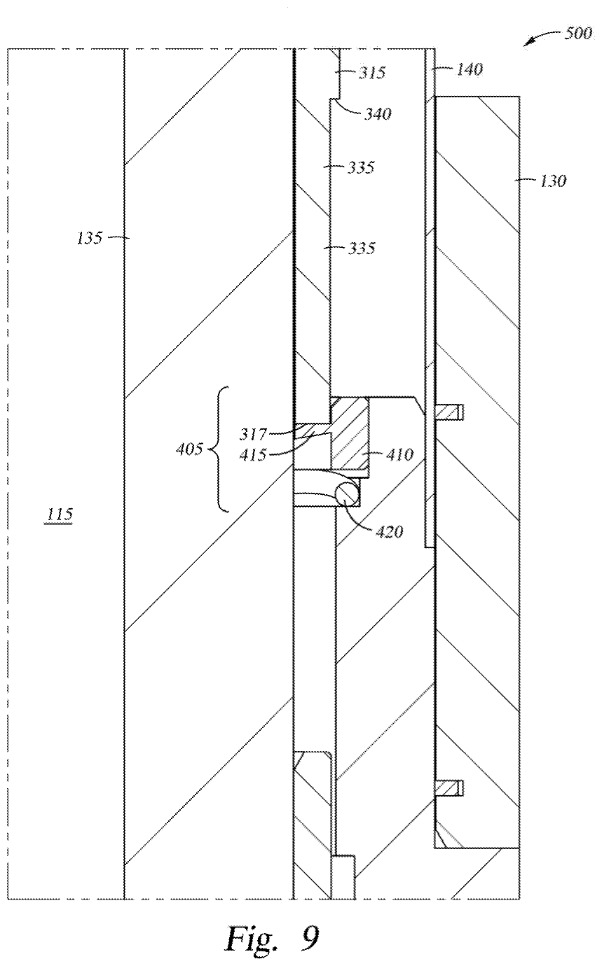

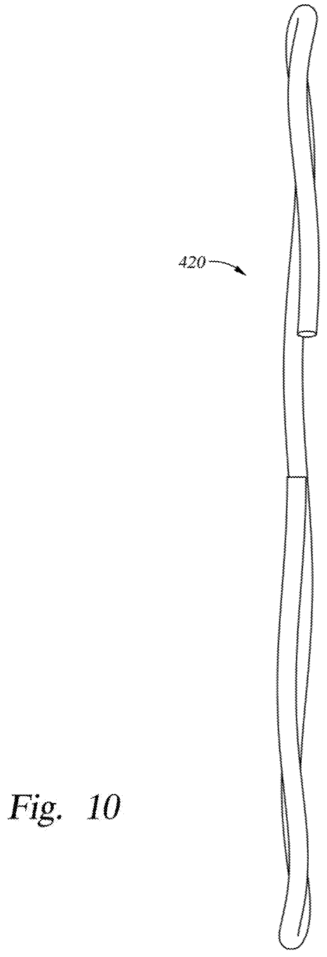

FIG. 9 is an enlarged section view showing a lower actuation portion of the tool 500. Visible is a lower, reduced diameter portion 335 of carrier 315 having a lower face 317 constructed and arranged to act on a ring assembly 405 in order to initiate the transition of the tool 500 to the activated position. The ring assembly includes a first ring 410 having an inwardly extending shearable arm 415 that is acted upon by lower face 317 and a wavy ring 420 constructed and arranged to flatten and reform in order to compensate and absorb shock from unrelated pressure events in the wellbore that might otherwise actuate the tool 500 at an unwanted time. FIG. 10 is a front view of the wavy ring 420 in its natural, wavy state.

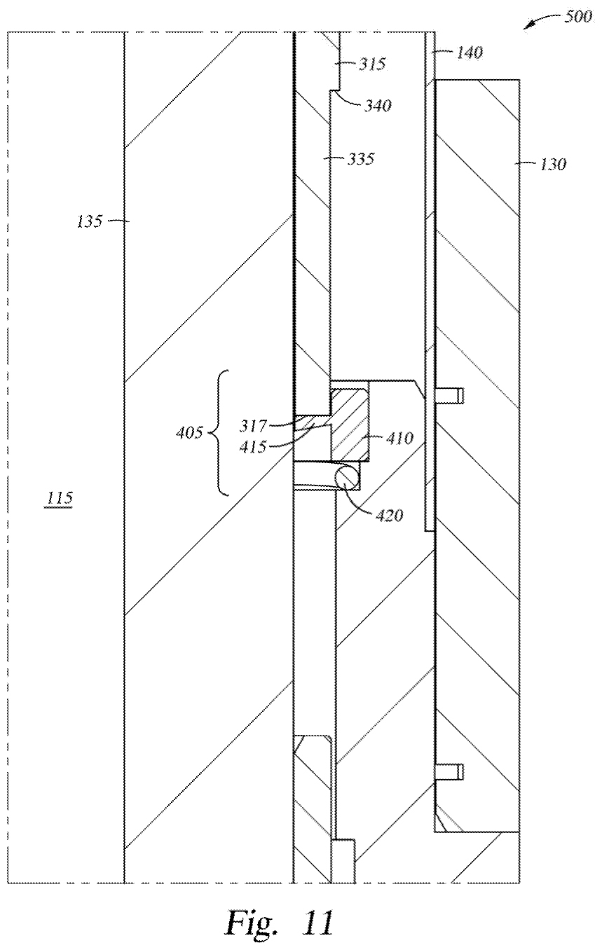

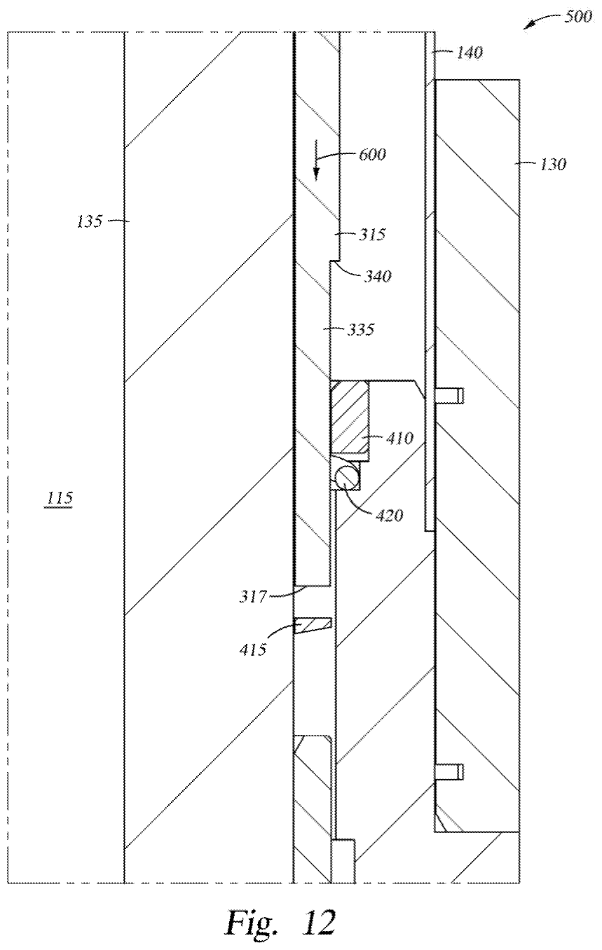

In the deactivated position shown in FIG. 9, face 317 is resting on shearable arm 415 and ring 420 retains its natural, wavy shape. FIG. 11 is an enlarged section view showing the same parts of the tool 500 as FIG. 9. In this view, the carrier 315 acting as an annular piston, has been acted upon at an upper end (not shown) by pressurized fluid and lower face 317 has applied enough pressure on the shearable arm 415 to cause it to flatten the wavy ring 420. In FIG. 12, an enlarged view of the same portions of the tool 500, fluid pressure applied to the carrier 315 has increased to the point where the shearable arm 415 of ring 410 has failed and the carrier 315 with its magnet groups 310 is moving downwards to its final, activated position. The downward movement is shown by arrow 600.

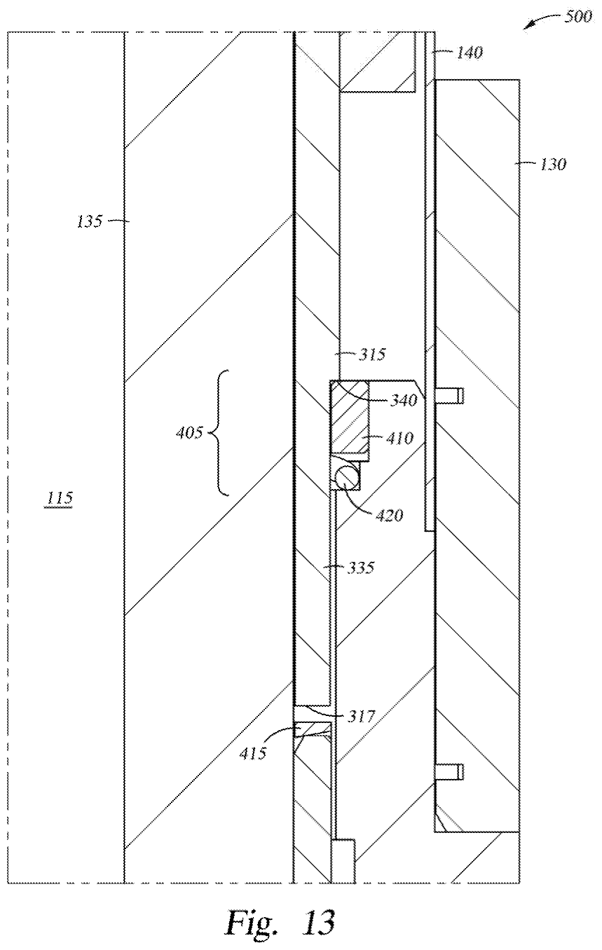

FIG. 13 is an enlarged section view showing the same portions of the tool 500 as the previous views, but showing the tool in its final activated position. In this position, the carrier has moved downwards relative to the other portions of the tool until shoulder 340 formed between the different diameters of the carrier has contacted an upper face of first ring 410 preventing additional downward movement.

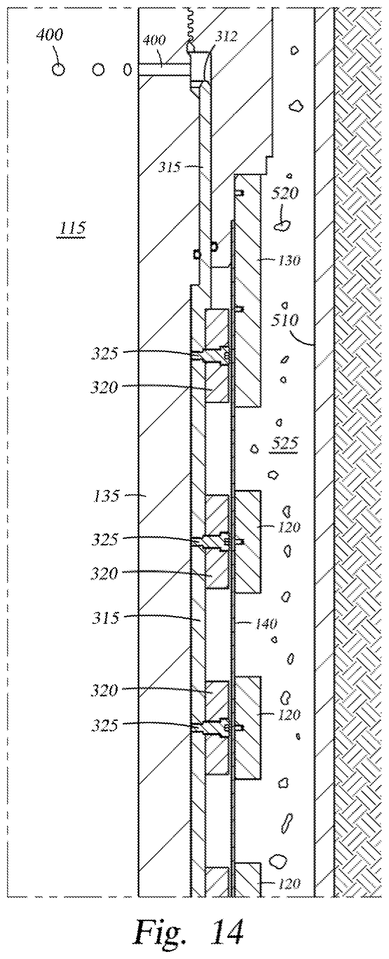

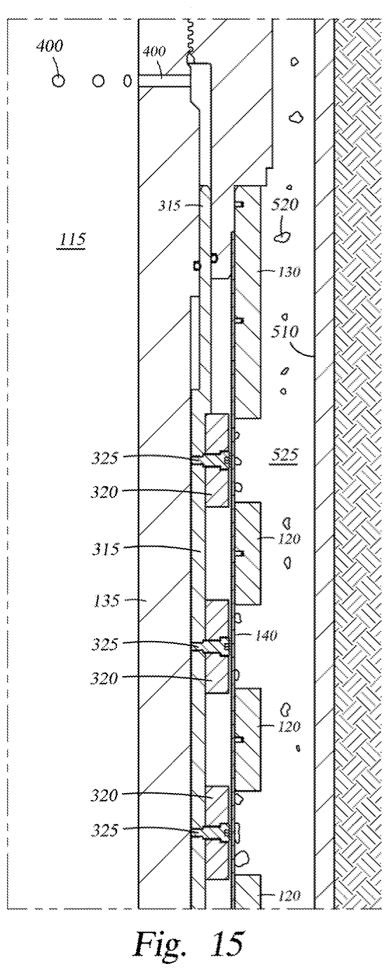

FIG. 14 is a section view showing an upper portion of the unactuated tool 500 in a wellbore 510 with debris 520 visible in an annular area 525 between the tool and the wellbore walls. As shown, each magnet 320 of each magnet group 310 is blocked by a cover 120, 130. The unactuated position of the tool would be typical during run-in or in the case of multiple operations in the wellbore, at some point prior to a time when collection of debris is needed. For example, in a drilling operation, the tool 500 might remain in its unactuated position until drilling has taken place. In other instances, the tool will be run-in but only actuated after fluid has been circulated in the annulus 525 to stir up debris 520 and make it easier to attract magnetically. FIG. 15 is a section view of the same upper portion of the tool 500 shown in FIG. 14. However, in FIG. 15 the tool is fully actuated and the magnets 320 are “uncovered” with only the particle shield 140 between the magnets and the debris 520 that is being collected.

In one embodiment, the tool 500 includes a reset assembly 700 permitting the tool to be easily moved to the unactuated state once it has been recovered at the surface of a well. Shifting the tool back to its original position is useful for cleaning the various parts of the tool before it is returned to a facility to be readied for another use.

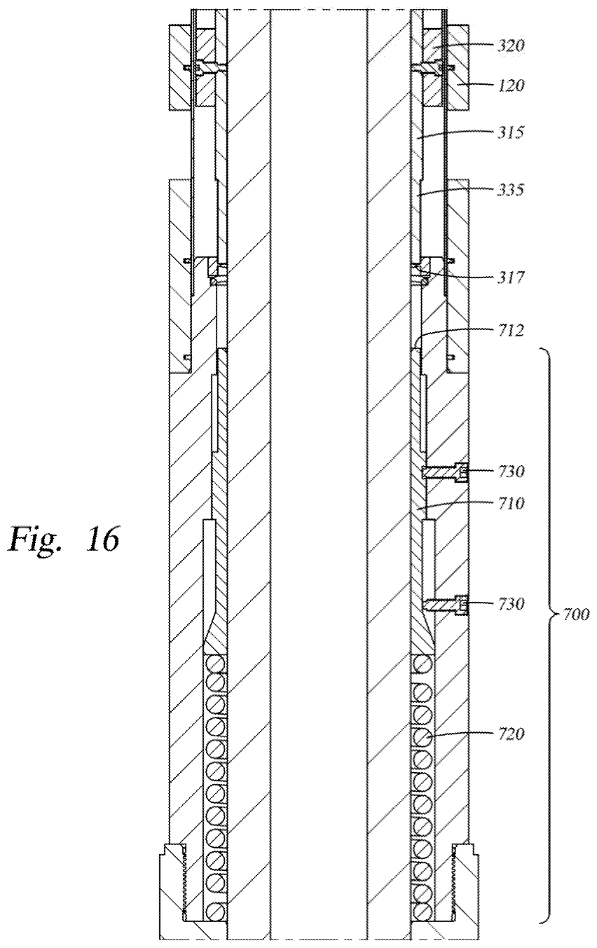

FIG. 16 is a section view of a reset assembly shown with the tool in the unactuated position. The reset assembly 700 is constructed and arranged to apply pressure to the carrier 315 in order to return it to its original position relative to the cover assembly 100. The assembly 700 includes a spring-loaded reset piston 710 with a spring 720 initially held in a compressed position be two retainers 730. In the embodiment shown, the spring remains compressed throughout the downhole operation of the tool 500.

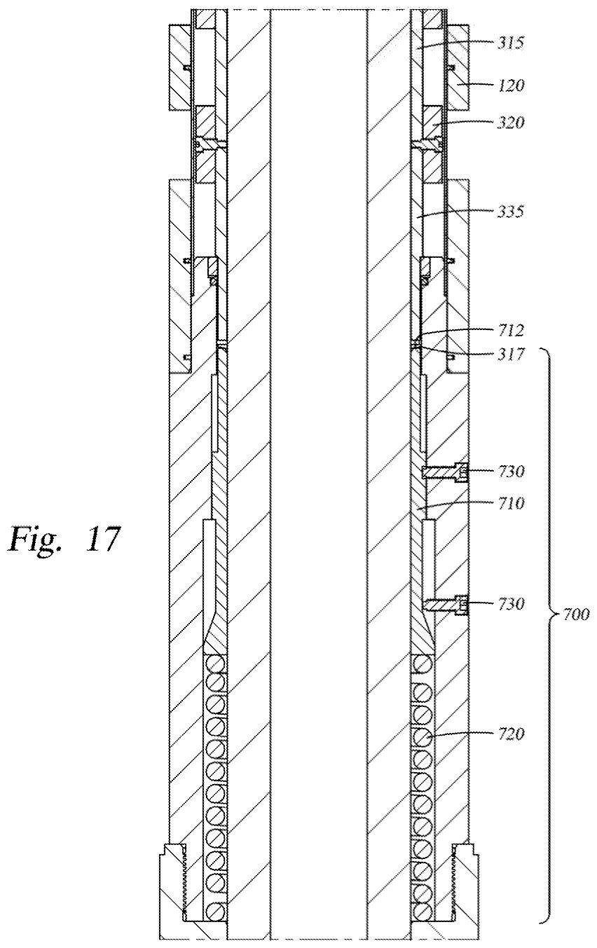

FIG. 17 is a section view of the reset assembly 700 shown with the tool in the actuated position. As shown, in the actuated position, the carrier 315 has moved downwards relative to the cover assembly 100 and the magnets 320 are exposed to the wellbore where they may attract debris (see FIG. 15). In this position the lower surface 317 of the reduced diameter portion 335 of the carrier 315 abuts an upper end 712 of the spring-loaded reset piston 710 which remains anchored in the charged/compressed position by the retainers 730.

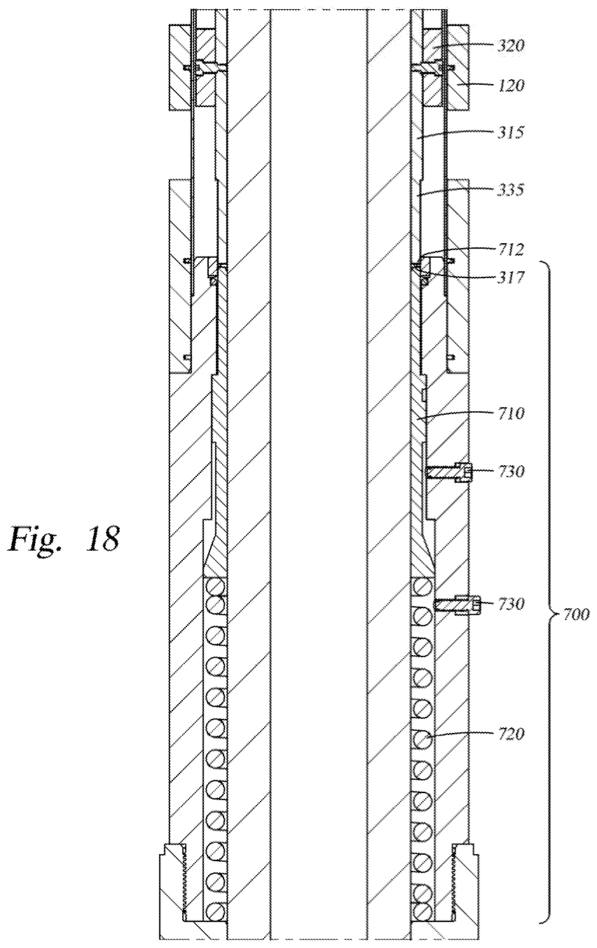

FIG. 18 is a section view of the reset assembly 700 shown after the tool 500 has been reset at the surface of the well. More specifically, retainers 730 have been loosened until they no longer interfere with the movement of the spring loaded reset piston 710 and the piston has moved upwards taking the magnet carrier 315 with it until the carrier is in the original, unactuated position with each magnet 320 blocked by a cover 120. In the position any collected debris can be removed prior to transporting the tool.

In operation, the tool 500 is run into a wellbore on a string of tubulars at such time as there is a need to collect iron-containing-type debris. The tool may be run-in alone or in combination with other tools like a drill bit. At any time there is a need for collection of debris, the tool can be actuated by providing a predetermined amount of fluid pressure, typically from the surface via port 400 to the upper surface 330 of the carrier 315. Typically, fluid is circulated in the annulus of the wellbore before or at the time the tool is shifted to its actuated position. Once a desired amount of debris is collected, usually determined by circulating over a set period of time, the tool can be removed, the debris discarded, and the tool re-set at the surface for another use.

While the foregoing is directed to embodiments of the present invention, other and further embodiments of the invention may be devised without departing from the basic scope thereof, and the scope thereof is determined by the claims that follow.

1. A debris collection tool, comprising:
a cover assembly having a plurality of covers spaced from one another along the length of the assembly creating a gap between adjacent covers;
a carrier disposed within the cover assembly and axial movable relative thereto, the carrier having a plurality of magnet groups spaced from one another along its length whereby, in an unactuated position of the tool, each of the plurality of magnet groups is under one of the plurality of covers and in an actuated position, each of the plurality of magnets is in a gap between covers.

2. The tool of claim 1, wherein at an upper end the carrier forms an annular piston and the carrier is movable within the cover assembly to shift the tool to the actuated position due to pressurized fluid being applied to the piston.

3. The tool of claim 2, further including a port providing a fluid path between a bore of the tool and the annular piston of the carrier.

4. The tool of claim 3, wherein the plurality of covers are spaced from one another by spacer pins.

5. The tool of claim 4, wherein each of the plurality of magnet groups comprises a plurality of magnets radially disposed around an outer surface of the carrier and fixed thereto with a fastener.

6. The tool of claim 1, wherein the cover assembly includes a particle shield constructed and arranged to separate the magnets from debris being magnetically collected.

7. The tool of claim 6, further including a ring assembly disposed in the carrier assembly at a lower end of the carrier and constructed and arranged to absorb shock from pressure events acting upon the piston of the carrier.

8. The tool of claim 7, wherein the ring assembly includes a first ring having an inwardly extending shearable arm that is acted upon by a lower face of the carrier and a wavy ring below the first ring constructed and arranged to flatten and reform in response to the pressure events.

9. The tool of claim 8, wherein a predetermined fluid pressure on the annular piston causes the shearable arm to fail and the carrier to move axially downwards to the actuated position.

10. The tool of claim 4, further including a reset assembly for returning the tool to the unactuated position.

11. The tool of claim 10, wherein the reset assembly incudes a spring-loaded reset piston constructed and arranged to urge the carrier to the unactuated position at a predetermined time.

12. The tool of claim 11, wherein the reset assembly further includes at least one retainer for maintaining the spring loaded carrier in a compressed position until the predetermined time.

13. A method of operating a debris collection tool in a wellbore comprising:
running the tool into the wellbore on a string of tubulars to a predetermined depth, the tool having a carrier with spaced magnets mounted thereon and axially movable in a cover assembly with spaced covers; and
providing fluid pressure to a piston surface formed on the carrier thereby causing the tool to move from a deactivated position wherein the magnets are covered, to an activated position wherein the magnets are exposed to the wellbore.

14. The method of claim 13, wherein the piston surface is at an upper end of the carrier and the fluid pressure causes the carrier to move from a first position in the cover assembly to a second, lower position.

15. The method of claim 14, wherein moving the tool to the actuated position requires causing a shearable arm on a ring to fail, the ring disposed in the cover assembly.

16. The method of claim 15, further including circulating fluid in the wellbore while the tool is in the activated position.

17. The method of claim 13 wherein moving the tool to the actuated position is a second downhole operation taking place after a first operation.

18. The method of claim 17, wherein the first operation is a drilling operation.

19. The method of claim 13, wherein fluid pressure to the piston surface is provided via a port extending from a bore of the tool to the piston surface.
